(19) United States
(12) Patent Application Publication
(10) Pub. No.: US 2022/0198553 A1
(43) Pub. Date: Jun. 23, 2022

(54) Methods, Systems and Computer Program Products for Connecting Sportsmen with Private Land

(71) Applicant: Charles S. Scott, Mebane, NC (US)

(72) Inventor: Charles S. Scott, Mebane, NC (US)

(21) Appl. No.: 17/555,988

(22) Filed: Dec. 20, 2021

Related U.S. Application Data
(60) Provisional application No. 63/128,400, filed on Dec. 21, 2020.

(51) Int. Cl. G06Q 30/06; G06Q 10/02

(52) U.S. Cl. CPC G06Q 30/0645; G06Q 30/0609; G06Q 10/02

(57) ABSTRACT

Methods for connecting parties in relation to sporting activities are provided. The methods include locating, by a renting party, available land using a hunt connect module; connecting the renting party to a registered landowning party after the renting party has been deemed safe by the hunt connect module; brokering a lease to the available land associated with the registered landowning party, the lease detailing terms of the lease including a location of land, a duration of the lease and types of activities included within the lease; and upon approval by both parties, scheduling a sporting activity based on the terms of the lease. At least one of the locating, connecting, brokering and scheduling is performed by at least one processor.

### CLAIM OF PRIORITY

The present application claims the benefit of and priority to U.S. Provisional Application No. 63/128,400, filed on Dec. 21, 2020, entitled Methods, Systems and Computer Program Products for Connecting Sportsmen with Private Land, the contents of which is hereby incorporated herein by reference as if set forth in its entirety.

### FIELD

Embodiments of the present inventive concept relate generally to hunting and fishing and, more particularly, to methods for obtaining rights to use private land for the same, and connecting with outfitters, guides, hunt clubs and the like.

### BACKGROUND

Sportsmen, for example, hunters, trappers and fisherman, are generally constrained by rules related to where and when they can hunt and fish. For example, fishermen and hunters either gain access through private or public (state managed) land. For private land, this limits outdoor sportsmen if they are traveling, new to an area, or do not have private land or access. State managed game lands are often over hunted leaving the animals pressured. Private land is generally governed by the same rules related to licenses and seasons, but non-landowners cannot hunt on private land without permission to do so from the landowner. Currently, in the market, there are very few digital platform offerings for the connection of sportsmen with hunting guides, outfitters, hunt clubs, and private landowners who are willing to allow non-owners to hunt and/or fish on their land or utilize their services.

### SUMMARY

Some of embodiments of the present inventive concept provide methods for connecting parties in relation to sporting activities. The methods include locating, by a renting party, available land using a hunt connect module; connecting the renting party to a registered landowning party after the renting party has been deemed safe by the hunt connect module; brokering a lease to the available land associated with the registered landowning party, the lease detailing terms of the lease including a location of land, a duration of the lease and types of activities included within the lease; and upon approval by both parties, scheduling a sporting activity based on the terms of the lease. At least one of the locating, connecting, brokering and scheduling is performed by at least one processor.

In further embodiments, locating may be preceded by creating a sportsman profile for the renting party, wherein creating the sportsman profile by the renting party includes providing identification information; providing emergency contact information; providing proof of age; providing proof of legal ability to participate in the sporting activities; and providing proof of possession of necessary licenses associated with the sporting activities; and executing terms and conditions associated with the sporting activities.

In still further embodiments, connecting may be preceded by creating a landowner profile for the landowning party, wherein creating the landowner profile includes providing identification information; providing proof of land ownership and ability to lease the land for the sporting activities and providing details about the land; and executing terms and conditions associated with the sporting activities, wherein the renting party and the landowning party are not allowed to connect until both parties have completed profiles and have executed the terms and conditions.

In some embodiments, scheduling may be preceded by execution of a liability waiver by the renting party and/or the landowner.

In further embodiments, scheduling may be followed by terminating the lease by the renting party and/or the landowner.

In still further embodiments, an entire payment for the lease may be refunded to the renting party if the renting party requests termination within a predefined time period.

In some embodiments, the renting party may be a sportsman and the landowning party may be at least one of a landowner, a hunt club, a private guide, and/or an outfitter. Related non-transitory machine-readable medium and computer embodiments are also provided.

### BRIEF DESCRIPTION OF THE DRAWINGS

FIG. 1 is a high level block diagram illustrating a system including devices having a hunt connect module thereon in accordance with some embodiments of the present inventive concept.

FIG. 2 is a block diagram illustrating a system including multiple “renters” and multiple landowners in accordance with various embodiments of the present inventive concept.

FIG. 3 is a block diagram illustrating details of modules included with the hunt connect module in accordance with some embodiments of the present inventive concept.

FIG. 4 is a map of an example property that may be available using the hunt control module in accordance with some embodiments of the present inventive concept.

FIG. 5 is a flowchart illustrating operations of hunt connect modules in accordance with some embodiments of the present inventive concept.

FIG. 6 is a diagram of a data processing system that may be used in devices in accordance with some embodiments of the present inventive concept.

### DETAILED DESCRIPTION

The inventive concept now will be described more fully hereinafter with reference to the accompanying drawings, in which illustrative embodiments of the inventive concept are shown. This inventive concept may, however, be embodied in many different forms and should not be construed as limited to the embodiments set forth herein; rather, these embodiments are provided so that this disclosure will be thorough and complete, and will fully convey the scope of the inventive concept to those skilled in the art. Like numbers refer to like elements throughout. As used herein, the term “and/or” includes any and all combinations of one or more of the associated listed items.

As used herein, the singular forms “a”, “an” and “the” are intended to include the plural forms as well, unless expressly stated otherwise. It will be further understood that the terms “includes,” “comprises,” “including” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As discussed above, currently there is no efficient way for sportsmen (e.g., hunters, trappers and fisherman) to obtain permission from landowners to hunt/fish on their land. Accordingly, embodiments of the present inventive concept provide methods, systems and computer program products to connect sportsmen (hunters/fishermen) with private landowners. As used herein, “landowners” refer to the person or persons who own the land and “land renters” or “renters” refer to the sportsmen that are granted use of the land by the “landowner.” Thus, some embodiments of the present inventive concept provide hunting and/or fishing access to privately owned land to specific person(s) (renters) amongst the general public. As will be discussed herein, some embodiments provide a mobile device application (“app”) that allows communication between the renters and landowners such that the renters may obtain permission to hunt/fish on land owned by another. However, it will be understood that embodiments of the present inventive concept are not limited to mobile device applications. For example, a web based application may also be provided for those who do not have access to a mobile device without departing from the scope of the present inventive concept.

As will be discussed further herein, using the correct interface, the landowner and renter may enter into a “lease” and the terms of the lease can be negotiated by the parties. For example, the lease may be set for a particular period of time ranging from hours in single day, a day, a week, a month and the like. However, the lease may also be procured for a duration of a particular hunting season potentially up to a full year. In some embodiments, the lease will not exceed a year. However, embodiments may be envisioned where the parties may enter into a lifetime pass that can only be terminated if the landowner sells the land that is being leased. These details may vary from lease to lease, and embodiments of the present inventive concept are not limited to a particular set of terms.

Embodiments of the present inventive concept may be available to all sportsmen, but may be particularly useful to those sportsmen/renters who are in urban/suburban areas who may have limited or no access to hunting land. The inventive concept may also be useful to hunt clubs to gain new members or provide access to different properties to expand success. Currently, transactions for hunt clubs are word of mouth. Embodiments of the present inventive concept may allow all communication to be digital and may enable opportunities for both parties. Accordingly, as discussed herein, there may not be a connection between sportsmen and landowners that did not previously exist. Both the landowner and renter may benefit from this connection. Renters are able to enjoy private land access and landowners may charge for the use of the land and make a profit. The amount of the profit depends on the length of the lease and may be negotiable between the parties. Private land may be less crowded than public land and, therefore, may provide a different hunting/fishing experience.

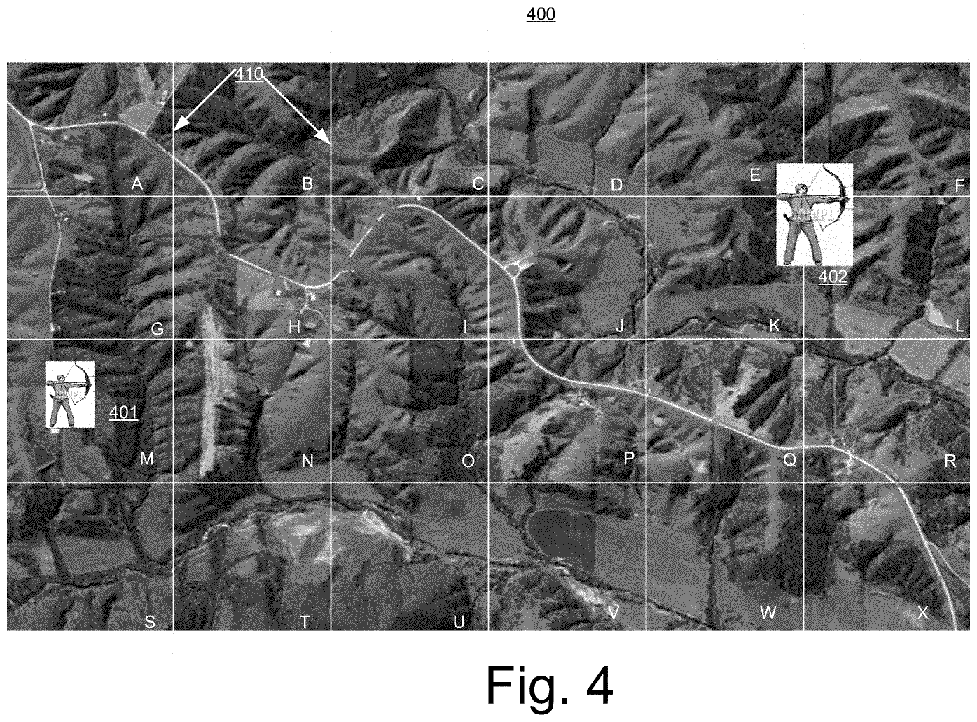

The renter and landowner may negotiate where the renter is allowed to hunt/fish on the land. For example, in some embodiments, landowners may lease as little as half an acre up to the entirety of their property for a set period of time; time frame or specific date and time. In some embodiments, a grid of each landowner's property may be made available via, for example, a global positioning system (GPS) and renters may select or be allocated specific grid locations via GPS or grid coordinates. For example, grid points may be blocked off by dropping pins in certain areas as will be discussed below with respect to FIG. 4. As will be discussed further below with respect to the figures, some embodiments of the present inventive concept may provide a way to connect landowners with one or more renters using a smart device, such as a smartphone. Making private lands available for sportsmen may reduce the number of sportsmen and traffic associated with public hunting areas. Furthermore, allowing use of private lands may ease the pressure on the animals in suburban areas and allow knowledge of animal movements and patterns that is generally unavailable when using public game lands. If a landowner knows where the wild game animals are and if they have baited the area (driven by state and federal guidelines), this knowledge may be obtainable.

In some embodiments the hunt connect module may raise funding and awareness for wildlife conservation through increasing hunting/fishing license sales (when needed) in the U.S and possible donations. The money from licenses that are purchased are used for national parks, state parks, research, and wildlife conservation efforts. Thus, increasing the sales of hunting licenses may also help protect the environment. In some embodiments of the present inventive concept, all persons utilizing the services should be a legal gun owner and sportsman. In other words, if a land renter wants to utilize the services provided, they will have to purchase state licenses.

Although embodiments of the present inventive concept are discussed herein specifically with respect to hunting and fishing, embodiments of the present inventive concept are not limited to these activities. Embodiment discussed herein may be used with respect to any sportsmen activity, for example, trapping, without departing from the scope of the present inventive concept.

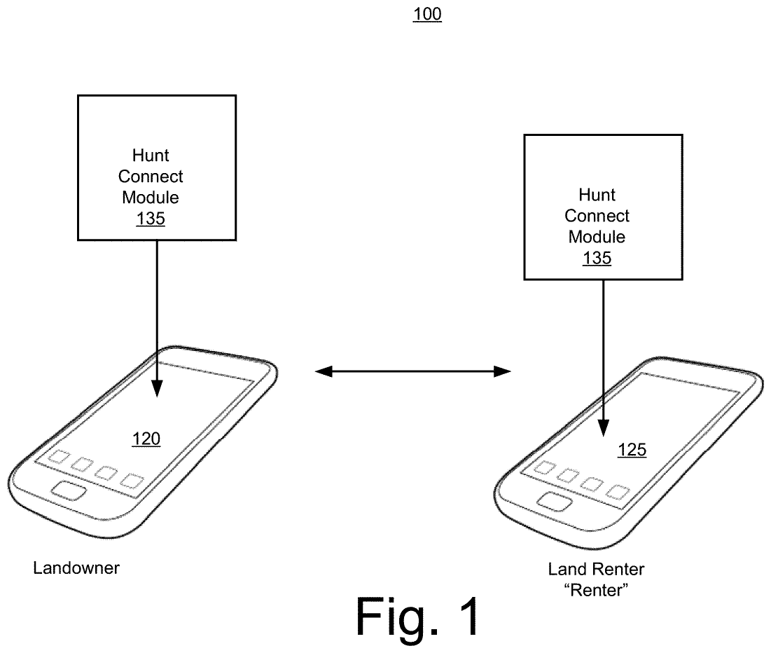

Referring now to FIG. 1, systems including the hunt connect module 135 in accordance with some embodiments of the present inventive concept. It will be understood that the hunt connect module (“Hunt Connect App” or “Guide Me App”) may operate on any device with any operating system, for example, iPhone operating system (IOS) or Android, without departing from the scope of the present inventive concept. As illustrated in FIG. 1, the system 100 includes at least two parties, the landowner and at least one renter. It will be understood that there may be more than one landowner and renter in some embodiments, but there must be at least one of each for a transaction.

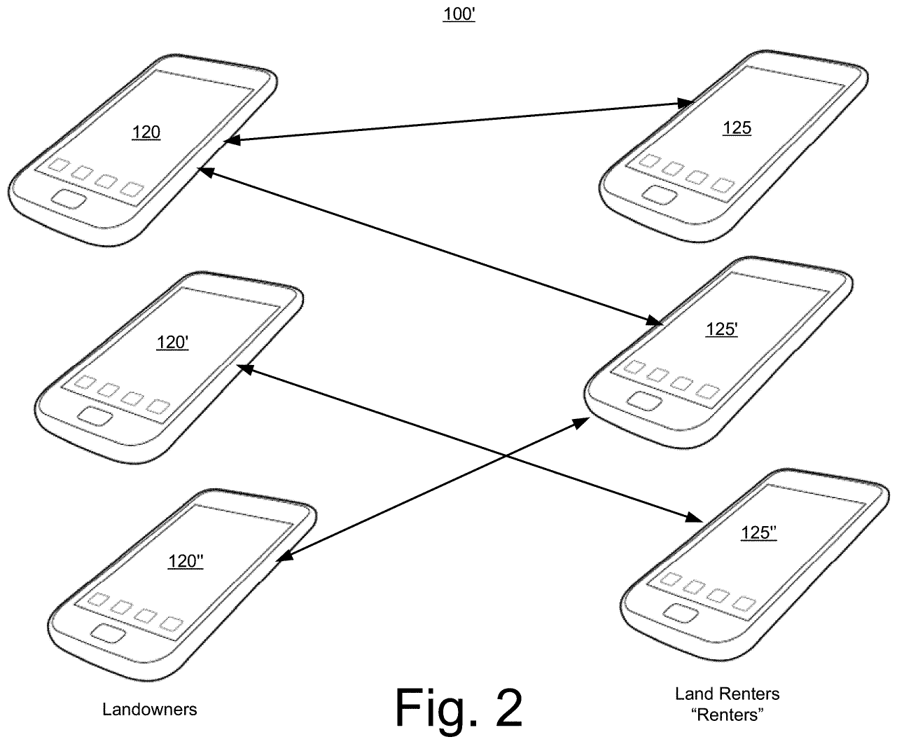

As illustrated in FIG. 2, the system 100′ includes three landowners 120, 120′ and 120″ and three renters 125, 125′ and 125″. Each of these devices is running the hunt connect module 135 in accordance with some embodiments of the present inventive concept. As illustrated in FIG. 2, one landowner 120 can communicate with more than one renter 125 and 125′. Similarly, one renter 125′ can talk to more than one landowner 120 and 120″.

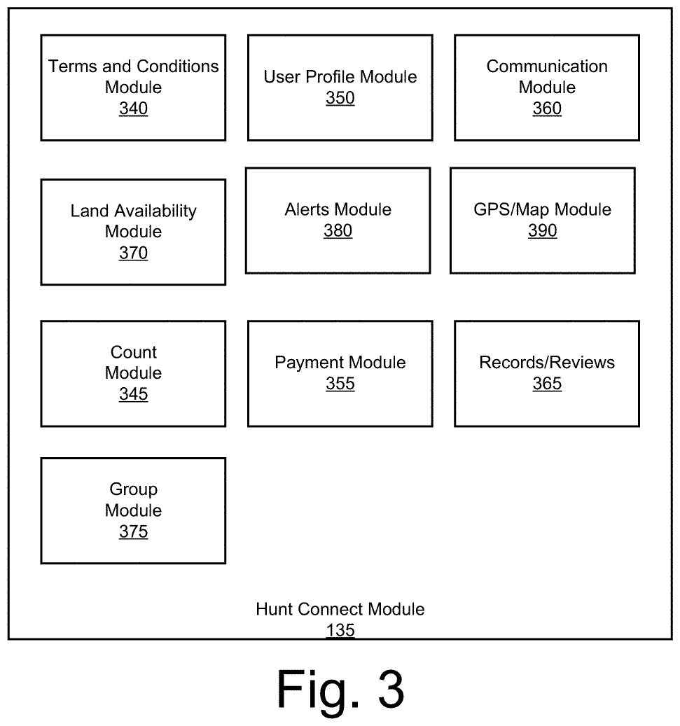

Example operations of the hunt connect module 135 in accordance with various embodiments of the present inventive concept will be discussed with respect to the figures. In particular, FIG. 3 is a block diagram illustrating various modules that may be included in the hunt connect module 135 in accordance with some embodiments of the present inventive concept. The hunt connect module 125 of FIG. 3 includes a terms and conditions module 340, a user profile module 350, communication module 360, a land availability module 370, an alerts module 380, a GPS/map module 390, a count module 345, a payment module 355, a record/reviews module 365 and a group module 375. It will be understood that the modules provided in FIG. 3 are provided for example only and that embodiments of the present inventive concept are not limited thereto. For example, one or more modules may be combined, or a module may be split into one or more pieces, without departing from the scope of the present inventive concept.

Referring again to FIG. 1 each party (landowner 120 and renter 125) has their own device and each device has a hunt connect module 135 installed thereon. The landowner may make their property or portions thereof available for “lease” by a hunter/fisherman on the hunt connect module 135. The renter may locate available land using the hunt connect module 135. Once the renter has identified available land, the two parties may be connected to one another using the hunt connect module 135 using their respective devices 120, 125.

It will be understood that safety in this agreement is very important and both parties (landowners & land renters) are generally required to read a written agreement including terms and conditions to protect both parties involved with the transaction and agreement. Before a land renter can utilize private land access, they must indicate they completed/complied with the relevant state regulations and, if necessary, a hunting safety course, use of legal tags and the like. For example, in some embodiments, the renters may check a box after reading all the conditions including a waiver to indicate that all information has been read, understood and agreed to. In some embodiments, all hunters must be at least eighteen years old and be able to legally carry a weapon, for example, a firearm or bow.

In some embodiments, the waiver may be a liability waiver. A liability waiver is a legal document that a person (the renter) who participates in an activity may sign to acknowledge the risks involved in his or her participation. By doing so, the landowner attempts to remove legal liability from the person who owns the land. The enforceability of such a waiver depends on state law, a jury, and the language of the waiver. For example, in the state of North Carolina, if the landowner is negligent and this negligence leads to the renter getting injured, the waiver may not be effective. It will be understood that these waivers may be customized to the landowner and to the activities that are involved with the lease of the land.

The renter is required to provide all information relevant to each particular situation including providing an emergency contact in-case there is an accident while the renter is present on the landowner's property. In some embodiments, the pertinent information may be entered using the hunt connect module 135 before the hunter is allowed to access details of available properties. In other words, the hunter/fisherman may not be allowed to proceed to the user interface associated with the hunt connect module 135 to locate and select land to rent if they do not meet all the necessary criteria. Furthermore, the landowner may retain the ability to terminate an agreement at any time they deem it necessary to do so and refunds may be provided to land renters where appropriate.

As discussed above, using the user profile module 350, the renter may create a profile and certify that the renter can hunt/fish legally and have completed the hunting safety requirements for their state regulations, have purchased the appropriate tags and the like. In some embodiments, the certification may be required before the land renter and the landowner make an agreement. The profile module sets a reminder/time (count module 345) for a certain period of time, for example, a year, when the various licenses may have to be renewed. When the period of time expires, the hunter/fisherman may have to re-certify that all standards have been met. The profile may also include a photograph of the renter and this may be stored in the Hunt Connect records 365. It will be understood that the profile may include many other details, for example, address, phone number, birthday and the like, without departing from the scope of the present inventive concept.

The hunt connect module 135 also includes safeguards for the renter. The landowner must show that they actually own the land and are authorized to lease it for hunting and/fishing. The hunt connect module 135 provides a mechanism to connect landowners with land renters to allow private lands to be used by sportsmen that do not own the land. The users of the hunt connect module, both landowners and renters, are responsible for their own behavior.

In some embodiments, the user may be prompted to select whether they are a landowner or a land renter. Once selected, the user will select the state they are in. Selection of state may be done in many ways, for example, a map may be provided, and the user may be able to select the location on the map. (GPS/map module).

If the user is a land renter, the user will set up and account and provide the information discussed above. For example, the user will provide their name, contact information, phone, emergency contact info, email address etc., a short bio, age, whether they have been convicted of any crimes. In some embodiments, if the user has existing warrants and/or any felonies, the user will not be allowed to use the hunt connect module. Convicted felons cannot carry firearms. As discussed above, the land renter may be required to indicate, for example, click a box, if they have passed all state regulations and actively have their hunting tags or fishing license before utilizing the property. The user may upload the various licenses etc. to the hunt connect module 135. For example, there may be a drop down menu used to upload tags and licenses which may last for one calendar year with the date they enter from there tags, once this year expires the account may be locked until updated information is provided.

If the user is a landowner, the user may also create a profile similar to the land renter. However, as discussed above, the landowner provides information such as legal landowner/or permission to lease land for landowner. This documentation may also be uploaded to the hunt connect module 135. The landowner may provide details of the land, for example, acreage, what types of hunting are available, for example, waterfowl, big game, whitetail, upland bird, ponds for fishing, and the like. The landowner may also include length of time they are willing to lease the property for hunting.

In some embodiments, the landowner may upload a map as illustrated in, for example, FIG. 4. The map may have a grid, for example, grid boxes A-X. The renter may be allocated one or more grids. For example, renter 401 is allocated grid M, but renter 402 is allocated grids E, F, K and L. The landowner may also upload the grid coordinates using, for example, a GPS/map module 390.

The landowner may also upload other stipulations for using the land, for example, firing directions (sectors of fire), stand or blind only, and the like. This information is not available to the public. The renter only sees this information when the renter is connected with the landowner. The landowner's profile may also include a calendar that may be automatically populated when the renter confirms the lease of the land.

Once the profiles have been created, a main page on a display associated with the hunt connect module 135 may include the map for both landowners and land renters. A landowner may see land renters willing to hunt within a selected radius of the land, for example, a 1, 5, 10, 20, 50, 100+ mile radius. The landowner can view the profile of the land renter and contact the renter if they are ready to lease property. In some embodiments, the landowner may be able to select a connection button on the renter's profile to connect with the renter.

In some embodiments, the communications module 360 (or connections module) is configured to include two statuses “pending connections” and “connected.” These may be displayed on a display of the device 120, 125 and may take the form of a tab or button. When selected, the “pending connections” tab may allow communication between the landowner and the renter. For example, once all the formalities discussed above are fulfilled, the user may be asked “do you want to establish a connection?” If yes, then the status changed to “connected.” In some embodiments, once the connection is confirmed, the hunt connect module 135 may request payment (payment module 355). The landowner has the ability to accept the connection request or deny the request. If accepted, the connection is established, if denied, the renter is notified.

The payment module 355 can be handled in many different ways, for example, Pay Pal, credit card, Venmo, Apple Pay and the like. All payment transactions may be encrypted and through the hunt connect module 135 to ensure privacy. In some embodiments, a refund option is provided to return the money to the user if, for example, the user decides he is unable to use the land as agreed. In some embodiments, if the request is made within two weeks of the agreement, a full refund may be provided to the land renter. Refunds may always be given at the discretion of the landowner. For the land renter, the app's interface will show a map with all the local landowners in a 1, 5, 10, 20, 50, 100+ mile radius. In these embodiments, the land renter can ping the landowner for permission to utilize their property. The notification will go to the landowner's inbox, once accepted from the landowner the pending connections page will be available. The land renter is now available to communicate with the landowner. Once they agree with the messenger to connect, they will both accept the connection for the date, and the connected tab will be available. Here, payment will take place and the land renter and landowners' calendars will be updated. There will be an option for the hunter to back out of the hunt, this needs to be done at least two weeks in advance in order to receive a refund from the landowner.

Furthermore, as discussed above, the landowner can decide to deny access to the renter for any reason, for example, if the land has become unsuitable for hunting/fishing. If the landowner removes permission to access his/her land, a full refund should be provided to the land renter.

The communication module 350 allows communication between those connected. For example, the parties may communicate about movement patterns of animals, trail cameras, scouting times, and the like. The parties can agree upon anything they want, in other words, the landowner and the renter can agree on details for meeting, scouting times, how many fish they are allowed to harvest according to state law, and the like. If there are multiple renters (which is preferred due to safety reasons), each renter may create their own account, profile etc. and can all be included in a “group hunt.” All the parties in the group hunt may communicate with one another using the hunt connect module 135. Furthermore, land renters can connect with active hunters outside of their group, so they can safely let each other know their locations and movements to and from the area they are utilizing. For an active hunt on a landowner's property, it will show if other hunters are utilizing the property for the safety of all parties involved.

In some embodiments, the landowner will communicate general terms and conditions for the hunt (provided by Hunt Connect). The Terms and Agreements are customizable. Forms may be provided and may include the following: Times and Dates to include scouting; payment amount; list of other, requirements; for example, required to be in a stand, blind, etc. The renter receives the agreement and may either sign and pay or deny the written agreement. If the renter denies the agreement, no connection may be made.

As discussed above, the agreement may be tailored to the particular connection. It behooves the landowner to be precise in the wording of the agreement and understand that by signing the agreement they are agreeing to the landowner's requests. After everything is signed and the transaction fee is paid, the use of the land by the renter is scheduled in the calendar section of the hunt connect module 135. The parties can connect on the module 135 or using any contact information, for example, phone number or email, provided in the user profile. If the terms and conditions transaction or financial transaction is denied for any reason, the agreement may remain pending until the issues are resolved. However, after a period of time, the request may be canceled completely, and the use of the land will not be scheduled.

There are various situations that the renter and landowner can agree upon. For example, what if the prey leaves the portion of the land the renter has leased? In some embodiments, the renter may contact the landowners and the renter and landowner may coordinate how they will retrieve and process the animal. In some embodiments, property lines and contact information for the surrounding landowners may be provided or visible.

As discussed above, in some embodiments of the present inventive concept, a group of hunters/fishermen may be established. (Group Module 375). It is generally safer to hunt in groups, so groups are encouraged. In some embodiments, a group can be created by a user, for example, on the user's bio page and party members may be added. A hunt request may be made through the group; thus, the landowner will accept all members of the group. Accepting all members of the group includes validating all members as discussed above, for example, age, criminal history, licenses, terms and conditions and the like. Payment for the group members may be made individually or as a group without departing from the scope of the present inventive concept. In some embodiments, payments may be automatically divided by the number of group members, for example, a group of two renters' payment will be divided equally in half. In some embodiments, once a group is established and payment is made, no additions to the group will be allowed.

In a situation where a hunter is hunting alone and, therefore, not with a group, the hunter/renter would have their locations services turned on their device, which may enable emergency search personnel to locate the individual in case of an emergency.

In some embodiments, the landowner may offer to be a guide for the renter or group of renters. Since the landowner knows the land, the landowner may help the hunter have a successful hunt. This may be agreed upon both parties during registration, for example, in the final terms and conditions page.

As discussed above, the terms and conditions may be customizable for each renter and landowner agreements. In some embodiments, there may be existing templates to make use of the hunt connect module 135 user friendly. Fore example, in some embodiments three templates may be offered in the form of Terms and Conditions selection boxes. The terms and conditions are important for protecting all parties involved. The first Terms and Conditions section may be used before the creation of account this will include the Initial Background information (that all given information is correct); follow hunting regulations per state guidance; will be a licensed with appropriate tags per state regulations and the like. In this first section there may also be a section for non-solicitation of phone numbers provided by both land renter and landowners. The second and third part for Terms and Conditions may be when the land renter and landowner connect and are going to agree upon the particulars of a given lease contract. The first Terms and Agreements may be generic with a few lines of fill in the blank by the landowner this will include the following: times and dates to include scouting, payment amount, list of other example requirements such as required to be in a stand, blind, guided or non-guided, etc. This part of the Terms and Conditions may include fiscal transaction (will list how money will be processed and percentages for Hunt Connect/Conservation efforts, for transaction between parties by providing a payment you accept the landowners price to lease their property for the given time). The third Terms and Condition agreement may include a generic protection for all parties involved including safety; game tags in accordance with state law/fishing license; inability to sue Hunt Connect for any injuries or criminal activity by both parties. This may also include landowner ability to call police if the property line is violated or any suspicious criminal activity is present. For the land renter Terms and Conditions (Second one that is sent to landowner) may also include a waiver indicating that the renter cannot be sued for following the directions of lease contract. It may further state in the contract that if the renter does not follow the rules, the renter can be sued for not following the landowner's agreement. These terms and conditions may be written as concisely as possible and may require a signature or check for signature before continuing. This puts the responsibility on both parties involved to proceed.

It will be understood that the waiver may also include an arbitration or mediation clause that requires the parties to meet and discuss any issues that arise under the agreement before any lawsuit is filed.

As illustrated in FIG. 4, the property 400 may have grid lines defining the various areas on the landowner's property. Property line/access may be given through the hunt connect module 135 showing where the renter can and cannot enter. At any time this particular line is broken, an alert may sound giving the renter time to proceed back to the appropriate location (alerts module 380). When an alert had been sounded, the landowner may choose to call the authorities. The GPS/map module 390 is configured such that the renter's location is known and the area of the land the renter has leased is known. GPS location tracking is enabled on the renter's phone and if the renter deviates from the agreed area the landowner may get a notification.

Landowners also contract issues related to removal of game after it is killed or caught. For example, the landowner may not want the animal cleaned on the property or may provide a location for the renter to clean the animal. In some embodiments, local game processors/taxidermist may provide/upload their services using the present inventive concept, which may encourage hunters to utilize their services.

Some embodiments of the present inventive concept provide a way for renters/landowners to review one another. Each user may be given the opportunity to review the other upon the completion of the event. The review may be a full review of the land renter/landowner, for example, each may be given a rating from 1 to 5 stars. For a renter, they may be rated based on how well they performed during their time utilizing the property. For the landowner, the renter may provide feedback on the property itself and how easy the landowner was to deal with. It behooves both parties to leave a rating because this allows accountability and reliance of both landowners and land renters for future leases.

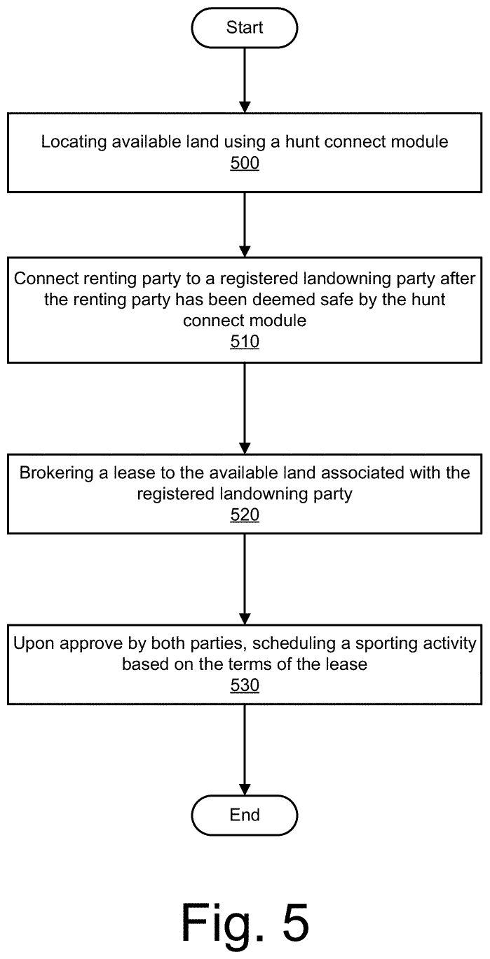

Referring now to FIG. 5, operations for connecting parties in relation to sporting activities in accordance with some embodiments of the present inventive concept will be discussed. As illustrated in FIG. 5, operations begin at block 500 by locating, by a renting party, available land using a hunt connect module. It will be understood that before the renting party is permitted to locate available land, the renting party (sportsman) must create a profile. In some embodiments, creating the sportsman profile by the renting party includes providing identification information; providing emergency contact information; providing proof of age; providing proof of legal ability to participate in the sporting activities; providing proof of possession of necessary licenses associated with the sporting activities and the like. In other words, the renting party (sportsman) is truly vetted and is deemed safer. The renting party is also asked to execute terms and conditions associated with the sporting activities and sign a liability waiver.

Once the renting party has located available land, the renting party is connected to a registered landowning party after the renting party has been deemed safe by the hunt connect module (block 510). Similar to the profile discussed above, the landowner (guide) is also required to create a profile. It will be understood that “landowning party” may refer a to a landowner, a hunt club, a private guide, and/or an outfitter without departing from the scope of the present inventive concept. Creating the landowner profile may include providing identification information; providing proof of land ownership and ability to lease the land for the sporting activities; providing details about the land; and the like. The landowner may also have to execute terms and conditions associated with the sporting activities. The renting party and the landowning party are not allowed to connect until both parties have completed profiles and have executed the terms and conditions. Again, both parties will execute a liability waiver before the transaction is complete.

Once the parties are connected, a lease to the available land associated with the registered landowning party may be brokered (block 520). The lease details terms of the lease including, for example, a location of land, a duration of the lease and types of activities included within the lease and the like. Upon approval by both parties, a sporting activity based on the terms of the lease is scheduled (block 530).

It will be understood that the lease may be terminated the renting party and/or the landowner. However, if the renting party waits too long to terminate, he/she may not receive a full refund. Furthermore, a party utilizing the application in accordance with embodiments of the present inventive concept may be both a renter and a guide/landowner without departing from the scope of the present inventive concept.

Operations illustrated and discussed with respect to FIG. 5 are provide as example only and, therefore, embodiments of the present inventive concept are not limited thereto.

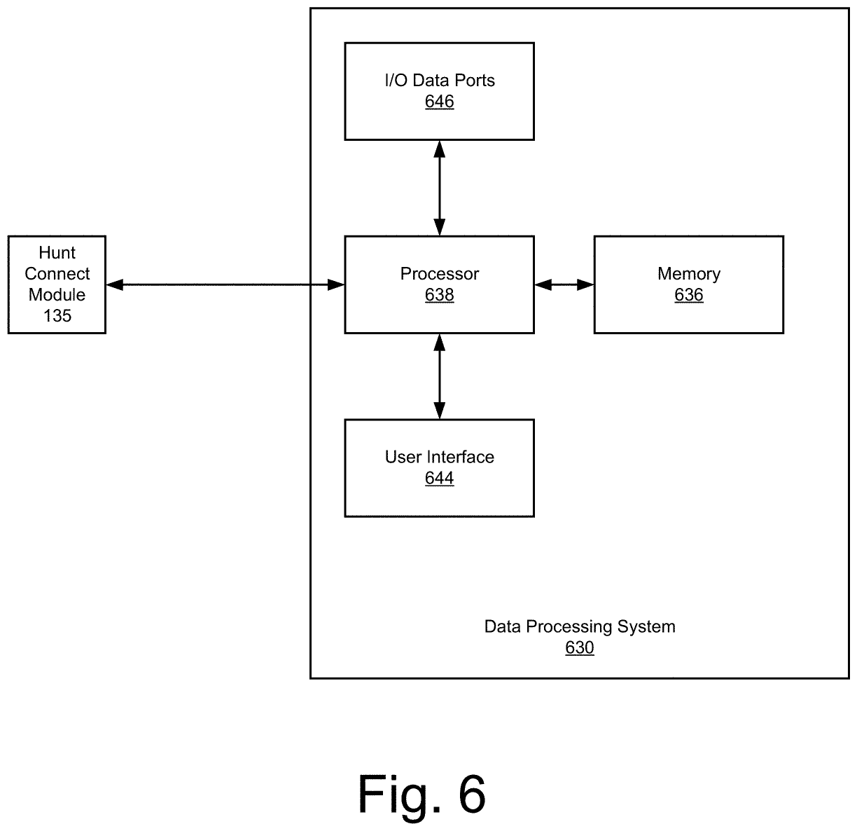

Embodiments discussed above are discussed with respect to providing a module that allowed hunters/fishermen to connect with private landowners. The hunt connect module 135 is loaded onto a device and must have access to a data processing system. The data processing system 630 of FIG. 6 may be used in devices in accordance with some embodiments of the present inventive concept is positioned. Exemplary embodiments of a data processing system 530 configured in accordance with embodiments of the present inventive concept will be discussed with respect to FIG. 6. The data processing system 630 may include a user interface 644, including, for example, input device(s) such as a keyboard or keypad, a display, a speaker and/or microphone, and a memory 636 that communicate with a processor 638. The data processing system 630 may further include I/O data port(s) 646 that also communicates with the processor 638. The I/O data ports 646 can be used to transfer information between the data processing system 630 and another computer system or a network using, for example, an Internet Protocol (IP) connection. These components may be conventional components such as those used in many conventional data processing systems, which may be configured to operate as described herein.

As discussed above, some embodiments of the present inventive concept provide methods, systems and computer program products to connect sportsmen (hunters/fishermen) with private landowners. Thus, some embodiments of the present inventive concept provide hunting and/or fishing access to privately owned land to specific person(s) (renters) amongst the general public.

Details of embodiments discussed above will now be discussed. In some embodiments of the present inventive concept, the hunt connect application may be offered at no charge. As discussed above, the hunt connect application may be used by two types of parties. First, the outdoor sportsman (referred to as “sportsmen”/renters) seeking guided opportunities/land for outdoor recreational use primarily through the means of hunting or fishing. Second, the guiding service, which will be known as “guides” throughout this document and also includes “landowners” (guide or landowner). Guides may also include, but is not limited to, outfitters, private guides, hunt clubs, or private landowners. As used herein, “landowner” refers to anyone willing to offer their service for access to portion of their property/companies service for a set time. The two parties (guides/landowners and sportsmen/renters) may connect using the Guide Me App/Guide Me App (iOS or Android).

Safety is of the utmost importance and, as discussed above, the App will require both parties (guides & sportsmen) to read a written agreement/terms and conditions page (to protect both parties involved with the transaction and agreement). For example, in some embodiments, before a sportsman can proceed to utilize private land access, they must select an agreement box that will state they have completed relevant state regulations and, if necessary, hunting safety courses/legal tags. Generally, all hunters must be 18 years old or older and must be legally allowed to carry a firearm or bow. Furthermore, an emergency contact number must be provided in-case of an emergency. In some embodiments, the emergency contact may be designated during the creation of a guide or sportsman profile. The sportsmen will not be allowed to proceed with connecting to guides if they do not meet the above criteria.

The guiding service can terminate the contract at any time and refunds may be provided to the sportsmen. In some embodiments, for sportsmen to receive a full refund, the termination must be requested at least two weeks in advance of the event. The App targets users who are new to the outdoors, live in an urban/suburban environment, or sportsmen new to an area. However, embodiments of the present inventive concept are not limited thereto. For example, currently experienced hunters and rural citizens can benefit from the connection embodiments of the present inventive concept provide. For example, hunt clubs requesting for new members, outfitters trying to advertise, startup guiding services with few clientele, a centralized platform for managing guiding activities for the calendar year.

Use of the Guide Me Application may increase education for conservation, environmental protection, and funding of conservation through the sales of hunting/fishing licenses. The money that someone uses to purchase a license goes back to wildlife conservation, research, and protection. As of 2020, there are 15,158,443 paid registered hunters in the United States, and use of the present inventive concept may increase this number.

An example of setting up an account with the application on the sportsman side will now be discussed. The sportsmen begins the process by downloading the Guide Me/Hunt Connect app from an app store. Once fully downloaded, the user opens the application and is presented with two options, sportsman and guide. As discussed above, guide is referred to as an outfitter business, or private entity such as a personal guide, landowner, and/or hunt club. The sportsmen chooses the correct option and proceeds to the creation of a profile. It will be understood that if the user is both a sportsman and guide, both options may be chosen. Details of these embodiments are discussed further below.

Once the selection is made, a user may select which state(s) they will be participating in. Once the sportsmen selects the state(s), operations proceed to the checklist/account creation page.

Creating an account profile may include the following information, which is provided for example only and, therefore, is not limited to this specific information in this specific form:
Age (selection box), users must be at least 18 years old to utilize the app.
Name, Username and Password (auto save enabled), contact information, and emergency contact information (which the landowner will have access to once connected).
State(s): depending on which state is chosen, a link for the fish/game wildlife page for that state is provided to ensure the sportsmen knows the regulations for the location where they are hunting.
Upload link: this section is where the sportsmen uploads a picture of their current license. It will be understood that the PII is not included, or if included, is protected. This upload link is set expire when the sportsman's license expires, so there will be a date range to enter on this section and an internal timer is created. For example, the timer may expire one year after the date the sportsmen enters and the sportsmen will receive a notification that will prompt them to renew this before proceeding with the app. Without this information the sportsmen can still create their profile but cannot connect to any guides.
Selection box for youth hunters. There will be a selection box (yes/no) for the option of bringing Youth Hunters that are less than 16 years of age where the state involved does not require youths to have a license and they are participating under the adult's license. It will be understood that the guides can deny this request and give an explanation as to why they may or may not feel comfortable with having a minor hunting/fishing on their property.
Description of the sportsmen: In this section, the sportsmen uploads a brief description of who they are and what type of activity they are looking for. This information can be used by the guides to query available sportsmen in their area/state.
Payment options: The sportsmen inputs their preferred payment option. This information is secured. The sportsmen can request not to provide this information until the transaction is getting ready to be completed with the guiding service. Lastly, the sportsmen agrees to Guide Me's terms and conditions, which protects both the company and parties involved. This completes the creation of the sportsmen's account. It will be understood that these steps are provided as an example, more or less steps may be provided without departing from the scope of the present inventive concept.

Once the account is created the sportsmen has access to their profile. In some embodiments, on the sportsmen's profile there may be tabs on the left-hand corner. The first tab may be an event calendar, which will include their event when connected to a guide.

The profile may further include a party tab. Parties are highly recommended, and rules are set by the guide to the number of people allowed in a party on their property, if any. Each party member must have their own separate account. These parties can have any member initiate a group activity, once one member requests a hunting or fishing trip through a guide, the other party member will be notified. The request may be accepted or denied the request).

When a sportsman selects a connection tab, he/she will be re-directed to the connection map page. This may be the main page that will automatically appear when viewing the apps interface. This page includes the map to their state(s) that they are requesting to hunt, fish, etc. In some embodiments, there may also be an option to click back into the United States map and see options in other states. However, the sportsmen cannot connect with any guides out of their state for a hunt. If the sportsmen wants to participate in an outside state hunt, they must go back into their profile settings and add a state/upload documentation stating there are eligible to participate in that specific state. Again, when you select on a state, a link for state's game and wildlife page will appear for the sportsmen to review in depth regulations, guidelines, etc. When viewing the map, the sportsmen and location services are turned on, the sportsmen will be able to view which private guides, outfitters, landowners and/or hunt clubs are requesting for their land/or services to be used. When the sportsman selects a guide's page, the sportsman will be redirected to separate page that has a description of the property and stipulations. For example, this information may include target activities; deer hunting, duck hunting, fishing, bear hunting, etc. Along with number of people per party. Here, the guides can provide other details such as animal activity, pictures from trail cameras of the animals, or pictures from previous successful guided trips. The description section for the property may include the following information: price for the activity and further rules set forth by the guide, and or contact information (phone number, email, etc.). It will be understood that other information may be provided. Furthermore, this information may also be sent upon the connection from the guide in the messaging portion. A calendar indicating dates the property can be utilized may also be provided, this includes information on which dates are already taken/not available. Once the sportsman has read through and makes the decision to utilize this property, they select the dates requested to participate and click the connect button. Selection of this button will immediately notify the guide and prompt the sportsman to fill out a terms and conditions button. For example, the terms and conditions may be generic indicating that the sportsman cannot sue Guide Me for any illegal activity, they are properly licensed, not a convicted felon, and the like. This event will be pending in sportsmen's account until the guide accepts the connection.

A pending/connected trips tab may provide the sportsmen the ability to see which guides they have reached out to. Once the guide decides to accept the connection, they will continue to a few more terms and conditions prompts, stipulations (for example, parties), and payment information. Once completed and the sportsmen has agreed to the conditions followed with the signature, the sportsman/guide are locked into the dates requested. If one or more parties can no longer commit to this date, the connection may be dropped, and a refund may be provided if they can drop the connection at least two weeks in advance of the date. This gives the guide enough time to find someone else to utilize their property for that given time. The sportsman's emergency contact will be sent to the guide in case of an incident. Once connected the sportsman will have the option of messaging the guide for further details as discussed further below.

A messaging section of the application will now be discussed. The messaging section provides an inbox on the account that will be for the connection tab. Once the connection has taken place, the sportsman is able to message the guide and request further details.

Once the lease expires and the activity has taken place, a review option will pop up for the sportsmen the next time they login to their profile. The sportsman may optionally review the landowner/guide and similarly, the guide may review the sportsman.

Use of the application in accordance with some embodiments of the present inventive concept by the guides will now be discussed. The guide terminology includes, for example, the following: hunt clubs, outfitters, private guides, landowners, Proxy landowners and the like (see below). Anyone who is giving access of property to sportsmen for a period fit this or multiple types of this category. Upon downloading the app, the guide is presented with the first interface with the two options, guide or sportsman. The guide chooses guide or both. Once selected, the guide is presented with a map of the United States and selects which state they will be leasing property in. Once selected, the Guide is prompted to create an account. For example, the Guide may be asked to provide: Name, Username and Password, Contact information, email and phone number. In some embodiments, this may be hidden until connected with at least one sportsman.

As used herein, a “proxy landowner” refers to a third-party member who is utilizing this account for someone else (meaning they will have permission from the landowner to lease out the property in their place. With many landowners being older and not necessarily having a desire to be involved personally with this app, but still wanting to make a profit using embodiments discussed herein, the application offers the option for them to still create revenue. Profit splitting may be performed outside the application. The proxy is responsible for knowing their state laws and uploading appropriate documentation. Embodiments of the present inventive concept are not responsible for misuse or someone committing an act of fraud. Embodiments discussed herein require an upload from the proxy landowner as a method to help law enforcement in case someone tries to commit fraud. However, if someone wishes to choose this method, a different set of rules and conditions may be provided to proceed with this option)

For guides that are landowners using private property (depending on which state is chosen a map will be pulled up of that state, if it is multiple states the landowner will have to map their property accordingly). On the detailed graphical map (e.g., google earth) the landowner locates their property. Once the landowner locates their property, the landowner may physically drop pins and map out the area where the sportsmen can utilize. For example, a graphical user interface (GUI) may be provided to facilitate mapping out the land. The landowner may pin the following: accessible land, do not shoot zones (e.g. Houses), do not enter zones (e.g. all zones not listed are considered do not enter zones), campsites, entrance and exit points and the like.

A guide/landowner uploads a statement of their property. Once mapped out the guide/landowner can proceed to the next section. If the guide is a hunt club, documentation supporting the legality of their club/properties in which they hunt may be uploaded. If the guide is an outfitters/private guides, they may upload any useful information of the places their services are, via public land guided hunts, private land hunts and their permissions, etc.

In an Activity Section the outfitters or private guides specify what their service offers. For landowners what is allowed on their property, for example, hunting, hunting—archery only, fishing, trapping, camping and the like. This section may also specify the number of persons allowed on the property (parties) and/or also the type of game listed, such as deer, ducks, bear, elk, rabbits, squirrel, bass, trout, panfish, etc.

In some embodiments, there are three parts to the Description section the first section block is for hands on outfitters/private guides, and hunt clubs. Here these guides describe what the purpose is for this account and the service provided. The second block is for guides that fall into the landowner category. Traditional landowners planning on just leasing their property and are hands off will be description of gate codes/keys, the animals, animal patterns, previous successes, trail camera pictures, pictures from previous hunts, etc. The third separate block is a brief terms and conditions put out by the guide for their property. In the description section the generic form covers the do's and do nots while utilizing the property. For example, do not shoot near the house, clean up after done, put out/bury campfires, etc. This section may also include details on payment. This description is not visible to the sportsmen and before the transaction takes place the sportsmen (and party) sign to agree to the terms and conditions set out by the guide. This section as detailed as the landowner will make it, but reasonable. In other words, the landowner cannot say “If I see trash, I will sue you for 1 million dollars.” Accordingly, in some embodiments, a lawyer may be consulted when creating a checklist of what to include and so the landowner cannot input anything to willingly hurt sportsmen. Separate from this terms and conditions, embodiments of the present inventive concept may offer one for both the landowner and sportsmen at the end of the account set up page and before the transaction takes place. It will be understood that the payment for the property should be visible to the sportsmen when they hover over the property to view it.

A portion of the application that is dedicated to bank information is fully secured. This is the portion of the application that allows the guide to receive payments from the sportsmen.

As discussed above, embodiments of the present inventive concept provide a terms and conditions section, which is generally the last step for the creation of the account is for the guide to accept terms and conditions of the application. It will be understood that these terms and conditions will include the necessity to understand their state laws fully, and understand the responsibility they are taking on to protect the renter. Once completed the guide can select create account and proceed to the main interface.

The main interface is similar to the interface discussed above with respect to sportsman. A main page is displayed with a map of the state of which they are currently in, and a highlighted star that will show their lands location or business location. As discussed above, a series of tabs may be provided on the main page, for example, on the left-hand corner. The first tab may be an event calendar which includes events when connected to a sportsman. In this tab the guide inputs the times for which the property is available. The profile tab allows any personal changes during the initial setup. The connect tab allows guides to view requested permissions from sportsmen. In particular, the guide can select the requests and view the sportsmen's profiles. Once the file is reviewed and the guide decides to accept, they agree to the pre-defined terms and conditions and press accept. Once the connection is accepted the guide and sportsmen will be able to message each other along with a calendar event posted, along with having their contact information and emergency contact information in case of an issue. In some embodiments, an opt out option may be provided for the guide to connect to sportsmen to gather more clientele. If the guide decides to decline the offer, the sportsmen will receive a notification stating their connection was declined. If the guide needs to cancel the activity, they can do so and the money will be refunded to the sportsmen. If the sportsmen cancels less than two weeks before the scheduled hunt, they may not receive a refunded. The messaging tab allows the guide to message the sportsmen and can obtain any further details, set up a time to talk, and the like.

Once the lease expires and the activity has taken place, a review option may be provided for the sportsmen the next time they login to their profile. This allows the sportsmen to review the landowner. These reviews may help future users to select good guides.

For the land renting option, when the sportsmen are getting ready to utilize the property they can “check in” to their activity and that will notify the guide/private landowner that they are there. However, this may not be practical since there may be little service where the land is located. Accordingly, check in is optional, but good practice to do when the sportsmen can. In some embodiments, the sportsmen may choose to send a notification that they are in route to the location. Since service may be an issue, both parties (primarily the sportsmen) will have their data saved to review for when the activity takes place. For example, saved data may include the property outline (sectors of fire, do not go zones, etc.). If the application is working correctly, with their location services on, sportsmen should be able to see where they are in relation to the property lines that were mapped out by the guide/private landowner.

In some embodiments, advertisements may be displayed on the application. The advertisement may be non-intrusive, but still advertise companies that customers could benefit from. For example, some companies may include, Drake Waterfowl, Ducks Unlimited, Quail Forever, Bass Pro Shops, local butcher shops, taxidermists and the like. In some embodiments, advertisements may appear on a banner across the bottom of the page.

With respect to reviews, after the activity takes place the guide and/or sportsmen will both be asked to give a 1-5-star review and a brief description why the particular number of stars has been selected, for example: their success or issue they might have experienced. It will behoove both parties involved to leave positive reviews. For the sportsmen, a positive review may motivate a guide to accept their next request. For the guide, a positive review may allow the sportsmen to feel comfortable with requesting permission, along with the potential for the landowner to up their price if they have major success on their property.

As discussed above, a user can be both a sportsmen and landowners/guide. If a guide is also a sportsman looking for other properties to utilize, the user can select both sportsmen and guide on the initial screen. Embodiments of the present inventive concept then combine all the initial profile creation entry data for both types of parties. When the user gets to their main page, they will have two tabs and can click back and forth to use both types of services the platform offers.

Some embodiments of the present inventive concept provide a website that corresponds with the application. The website may encourage guides/private landowners who may not have smartphones to still participate. All data would be compatible with the application but could be performed using a personal computing device. Some embodiments of the present inventive concept may provide for subscriptions.

As will be appreciated by one of skill in the art, the inventive concept may be embodied as a method, data processing system, or computer program product. Accordingly, the present inventive concept may take the form of an entirely hardware embodiment or an embodiment combining software and hardware aspects all generally referred to herein as a “circuit” or “module.” Furthermore, the present inventive concept may take the form of a computer program product on a computer-usable storage medium having computer-usable program code embodied in the medium. Any suitable computer readable medium may be utilized including hard disks, CD-ROMs, optical storage devices, a transmission media such as those supporting the Internet or an intranet, or magnetic storage devices.

Computer program code for carrying out operations of the present inventive concept may be written in an object-oriented programming language such as Java®, Smalltalk or C++. However, the computer program code for carrying out operations of the present inventive concept may also be written in conventional procedural programming languages, such as the “C” programming language or in a visually oriented programming environment, such as VisualBasic.

The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

The inventive concept is described in part above with reference to a flowchart illustration and/or block diagrams of methods, systems and computer program products according to embodiments of the inventive concept. It will be understood that each block of the illustrations, and combinations of blocks, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the block or blocks.

In the drawings and specification, there have been disclosed exemplary embodiments of the inventive concept. However, many variations and modifications can be made to these embodiments without substantially departing from the principles of the present inventive concept. Accordingly, although specific terms are used, they are used in a generic and descriptive sense only and not for purposes of limitation, the scope of the inventive concept being defined by the following claims.

That which is claimed is:

1. A method for connecting parties in relation to sporting activities, the method comprising:
locating, by a renting party, available land using a hunt connect module;
connecting the renting party to a registered landowning party after the renting party has been deemed safe by the hunt connect module;
brokering a lease to the available land associated with the registered landowning party, the lease detailing terms of the lease including a location of land, a duration of the lease and types of activities included within the lease; and
upon approval by both parties, scheduling a sporting activity based on the terms of the lease,
wherein at least one of the locating, connecting, brokering and scheduling is performed by at least one processor.

2. The method of claim 1, wherein locating is preceded by:
creating a sportsman profile for the renting party, wherein creating the sportsman profile by the renting party includes providing identification information; providing emergency contact information; providing proof of age; providing proof of legal ability to participate in the sporting activities; and providing proof of possession of necessary licenses associated with the sporting activities; and
executing terms and conditions associated with the sporting activities.

3. The method of claim 2, wherein connecting is preceded by:
creating a landowner profile for the landowning party, wherein creating the landowner profile includes providing identification information; providing proof of land ownership and ability to lease the land for the sporting activities and providing details about the land; and
executing terms and conditions associated with the sporting activities, wherein the renting party and the landowning party are not allowed to connect until both parties have completed profiles and have executed the terms and conditions.

4. The method of claim 2, wherein scheduling is preceded by execution of a liability waiver by the renting party and/or the landowner.

5. The method of claim 1, wherein scheduling is followed by terminating the lease by the renting party and/or the landowner.

6. The method of claim 5, further comprising refunding an entire payment for the lease to the renting party if the renting party requests termination within a predefined time period.

7. The method of claim 1, wherein the renting party is a sportsman and the landowning party is at least one of a landowner, a hunt club, a private guide, and/or an outfitter.

8. At least one non-transitory machine-readable medium comprising a set of instructions executable on at least one computing device to cause the at least one computing device to connect parties in relation to sporting activities, the set of instructions to:
locate, by a renting party, available land using a hunt connect module;
connect the renting party to a registered landowning party after the renting party has been deemed safe by the hunt connect module;
broker a lease to the available land associated with the registered landowning party, the lease detailing terms of the lease including a location of land, a duration of the lease and types of activities included within the lease; and
upon approval by both parties, schedule a sporting activity based on the terms of the lease.

9. The at least one non-transitory machine-readable medium of claim 8, wherein the set of instructions further configured to:
create a sportsman profile for the renting party, wherein creating the sportsman profile by the renting party includes providing identification information; providing emergency contact information; providing proof of age; providing proof of legal ability to participate in the sporting activities; and providing proof of possession of necessary licenses associated with the sporting activities; and
execute terms and conditions associated with the sporting activities.

10. The at least one non-transitory machine-readable medium of claim 9, the set of instruction further configured to:
create a landowner profile for the landowning party, wherein creating the landowner profile includes providing identification information; providing proof of land ownership and ability to lease the land for the sporting activities and providing details about the land; and
execute terms and conditions associated with the sporting activities, wherein the renting party and the landowning party are not allowed to connect until both parties have completed profiles and have executed the terms and conditions.

11. The at least one non-transitory machine-readable medium of claim 9, the set of instruction further configured to facilitate execution of a liability waiver by the renting party and/or the landowner prior to scheduling the sporting activity.

12. The at least one non-transitory machine-readable medium of claim 8, the set of instruction further configured to facilitate termination of the lease by the renting party and/or the landowner.

13. The at least one non-transitory machine-readable medium of claim 12, the set of instruction further configured to refund an entire payment for the lease to the renting party if the renting party requests termination within a predefined time period.

14. The at least one non-transitory machine-readable medium of claim 8, wherein the renting party is a sportsman and the landowning party is at least one of a landowner, a hunt club, a private guide, and/or an outfitter.

15. A computer for connecting parties in relation to sporting activities, the computer comprising:
one or more processors; and
a non-transitory computer readable medium to store a set of instructions executable by the one or more processors, the set of instructions to cause the one or more processors to:
locate, by a renting party, available land using a hunt connect module;
connect the renting party to a registered landowning party after the renting party has been deemed safe by the hunt connect module;
broker a lease to the available land associated with the registered landowning party, the lease detailing terms of the lease including a location of land, a duration of the lease and types of activities included within the lease; and
upon approval by both parties, schedule a sporting activity based on the terms of the lease.

16. The computer of claim 15, wherein the set of instructions to cause the one or more processors further to:
create a sportsman profile for the renting party, wherein creating the sportsman profile by the renting party includes providing identification information; providing emergency contact information; providing proof of age; providing proof of legal ability to participate in the sporting activities; and providing proof of possession of necessary licenses associated with the sporting activities; and
execute terms and conditions associated with the sporting activities.

17. The computer of claim 16, wherein the set of instructions to cause the one or more processors further to:
create a landowner profile for the landowning party, wherein creating the landowner profile includes providing identification information; providing proof of land ownership and ability to lease the land for the sporting activities and providing details about the land; and
execute terms and conditions associated with the sporting activities, wherein the renting party and the landowning party are not allowed to connect until both parties have completed profiles and have executed the terms and conditions.

18. The computer of claim 16, wherein the set of instructions to cause the one or more processors further to facilitate execution of a liability waiver by the renting party and/or the landowner prior to scheduling the sporting activity.

19. The computer of claim 15, wherein the set of instructions to cause the one or more processors further to facilitate termination of the lease by the renting party and/or the landowner.

20. The computer of claim 19, wherein the set of instructions to cause the one or more processors further to refund an entire payment for the lease to the renting party if the renting party requests termination within a predefined time period.
